(19) United States
(12) Patent Application Publication
(10) Pub. No.: US 2026/0125532 A1
(43) Pub. Date: May 7, 2026

(54) POLYAMIDE COMPOSITION PREPARED FROM A POWDER OF POLYAMIDES TO BE RECYCLED

(71) Applicant: ARKEMA FRANCE, COLOMBES (FR)

(72) Inventors: Thomas PRENVEILLE, SERQUIGNY (FR); Ornella ZOVI, SERQUIGNY (FR); Florent ABGRALL, SERQUIGNY (FR)

(21) Appl. No.: 19/114,586

(22) PCT Filed: Sep. 22, 2023
(86) PCT No.: PCT/EP2023/076263

§ 371 Date: Mar. 24, 2025

(30) Foreign Application Priority Data
Sep. 23, 2022 (FR) 2209690

(51) Int. Cl. C08J 11/06; B29B 9/06; B29B 17/04; B29K 77/00; B29K 105/26; C08J 3/00; C08L 77/02

(52) U.S. Cl. CPC C08J 11/06; B29B 9/06; B29B 17/0404; C08J 3/005; C08L 77/02; B29B 2017/042; B29K 2077/00; B29K 2105/26; B29K 2995/0088; C08J 2377/02; C08L 2205/025; C08L 2207/20

(57) ABSTRACT

The application relates to a method for preparing a polyamide composition, which comprises the steps of:
a) providing a mixture comprising a virgin polyamide vPA and a polyamide to be recycled rPA in the form of an untransformed powder resulting from additive manufacturing by sintering or from a coating method by powdering or by electrostatic spraying, or powder obtained by grinding a polyamide-based part of an object to be recycled;
b) kneading the mixture in the molten state, as a result of which a polyamide composition is obtained; and
c) recovering the polyamide composition.
   The invention also relates to the polyamide composition obtained and to the uses thereof for preparing articles by extrusion, injection or overmoulding.

The present invention relates to: a polyamide composition preparation method for preparing a polyamide composition from untransformed powder resulting from additive manufacturing by sintering or from a method by powdering or by electrostatic spraying, or a powder obtained by grinding a polyamide-based part of an object to be recycled; a polyamide composition; and the use thereof for preparing articles.

Additive manufacturing (AM, as per the accepted terminology) has experienced rapid growth in recent years, in particular thanks to the possibility of designing objects having very diverse forms and shapes, the short duration between design and production, and the associated environmental and economic advantages.

The agglomeration of powders by melting or melt agglomeration (hereinafter “sintering”) is caused by radiation, such as for example by means of a laser beam (“laser sintering” or “selective laser sintering” SLS as per the accepted terminology), infrared radiation, UV radiation, or any source of electromagnetic radiation that enables the powder to be melted layer by layer in order to produce three-dimensional objects. The SLS technique produces a part by applying powders layer by layer, each layer being in the form of a thin powder bed, generally of the order of 100 μm. A laser is used in order to melt part of this powder at the desired location, and thereafter a new layer of powder is deposited. The process is repeated until a thermoplastic polymer object is formed layer by layer.

Other methods that may also be cited include selective sintering processes using an absorber, in particular technologies known as “High Speed Sintering” (HSS) and “Multi-Jet Fusion” (MJF). In these technologies, the manufacturing of 3D objects is also done layer by layer, using a polyamide-based powder which is melted in a controlled manner for each layer constituting the 3D object: an absorber is deposited over the layer (by means of for example a liquid ink in the “inkjet method”) before exposing the layer to electromagnetic radiation (for example infrared) which causes the melting of the areas containing said absorber.

Sintering generates a large quantity of untransformed powder. For each layer, the powder that has not been targeted by the radiation is not incorporated into the final object. Therefore this results in a lot of powder remaining untransformed.

This untransformed powder is difficult to recover because it is generally degraded. In fact, the powder bed is preheated and maintained at a temperature close to the melting point of the powder, typically 5 to 15° C. below its melting point. This enables proper fusion of the powder targeted by the laser as well as good definition of each layer of the object formed by the laser. At this temperature, the untransformed powder undergoes ageing degradation such as solid-state polycondensation and oxidation reactions. This leads to an increase in the length of the polymer chain, resulting in a decrease in the melt flow rate (MFR). As a result, these degraded powders cannot usually be directly reused in the subsequent sinter-based additive manufacturing process, particularly when the viscosity of the degraded powder varies far too significantly from that of the original powder. Any attempt to reuse these powders results in parts that have a poor surface finish, for example having an orange peel-like appearance, as well as diminished mechanical properties, in particular lower elongation at break, due to the defects acting as rupture initiators in tensile tests.

Recycling of this untransformed powder for other types of transformation processing (extrusion, injection) is not easy. This is because heating during the sintering technique affects the intrinsic viscosity of the powder. Generally speaking, extrusion or moulding of this degraded powder results in articles that are spongy and/or whose mechanical properties, in particular with respect to mechanical strength, and aesthetic properties (particularly with regard to colour, which tends towards brown) are inferior to those of articles formed from virgin polymer.

A large quantity of waste is thus generated by sinter-based additive manufacturing methods in the form of degraded untransformed powder. Very little of this powder actually gets recycled.

Considering the example of polyamide 12 (PA12), which is the main type of plastic used in the SLS method, PA12 powder waste can represent up to 50%, or even up to 90%, of the total quantity of powder used in the process. This represents a significant loss of PA12 powder, due to the fact that this waste powder must be disposed of.

The literature reports a number of attempts to recycle this waste polyamide powder. The patent application US 2022/0064405 describes a recycled polyamide composition that comprises a polyamide waste, preferably derived from additive manufacturing, a lubricating agent, and a crystallising agent. The invention that is the subject matter of this application is based on increasing the crystallisation temperature and enhancing the fluidity conferred by these agents. The composition described in this application does not contain virgin polyamide, ie it is free of virgin polyamide.

There therefore exists a need for recycling polyamide powder wastes resulting from additive manufacturing.

Furthermore, polymer powders are known to be used for manufacturing coatings for substrates, particularly metal substrates, typically by powdering or electrostatic spraying. A powdery polymer composition is applied over the substrate in the form of a loose powder, for example by means of electrostatic spraying or by immersing the substrate to be coated in a fluidised bed of powder. The polymers used for producing powders are usually thermosetting resins, however, thermoplastic polymers may also be used. Owing to their high chemical and thermal resistance, polyamides are the polymers of choice for demanding applications, such as coating of dishwasher baskets.

However, these powders are not easily recyclable. In fact, the fraction of powder that does not reach the substrate during the spraying process, known as ‘overspray’, which it is desirable to recover for recycling, generally does not have the same composition and/or the same properties as the powder initially used in the process, such that the coatings obtained therefrom do not match the original powder in terms of appearance and properties.

There therefore exists a need for recycling polyamide powder wastes resulting from a coating method by powdering or by electrostatic spraying.

The poorer mechanical properties of polyamide powder wastes resulting from additive manufacturing or from a coating method by powdering or by electrostatic spraying, in particular the reduced elongation at break, render them less attractive than virgin polyamides, in particular for the preparation of articles.

Finally, there exists a need for recycling numerous polyamide-based parts belonging to defective objects and/or in need of recycling in order to promote the circular economy and reuse of the material. Due to the previous use to which these parts have been subjected, the polyamide contained therein has properties that are in general inferior to those of a virgin polyamide.

One of the objectives of the present patent application is to provide the ability to recycle untransformed powders resulting from additive manufacturing or from a coating method by powdering or by electrostatic spraying, or powders obtained by grinding a polyamide-based part of an object to be recycled.

One of the objectives is to reduce the environmental impact and to reduce the cost price of:
additive manufacturing methods or coating methods by powdering or electrostatic spraying, by recycling the untransformed powders thereof;
methods for preparing new polyamide articles making use by way of raw material, of the said untransformed powders or of a powder obtained by grinding a polyamide-based part of an object to be recycled;

One of the objectives of the patent application is to provide a PA11 or PA12 polyamide composition that has certain mechanical and/or physicochemical properties that are better than those of a polyamide composition prepared from exclusively virgin polyamides.

One of the objectives of the patent application is to provide a polyamide composition that offers enhanced processability (ie suitability for operational implementation, in transformation processes) by extrusion, injection moulding or overmoulding.

To this end, according to a first object, the invention relates to a composition preparation method for preparing a polyamide composition which comprises the steps of:
a) providing a mixture comprising:
from 5 to 90% by weight of a virgin polyamide vPA;
from 10 to 95% by weight of a polyamide to be recycled rPA;
the polyamide to be recycled rPA being in the form of an untransformed powder resulting from additive manufacturing by sintering or from a coating method by powdering or by electrostatic spraying, or of a powder obtained by grinding a polyamide-based part of an object to be recycled;
b) kneading the said mixture in the molten state (melt kneading), as a result of which a polyamide composition is obtained;
c) recovering the said polyamide composition.

The method comprises a step a) of providing a mixture comprising a virgin polyamide vPA; a polyamide to be recycled rPA, the polyamide to be recycled rPA being in the form of a powder.

For the purposes of this patent application the term ‘vPA’ refers to a virgin polyamide. The latter has not undergone any prior transformation, and in particular it has not been used in a prior additive manufacturing method by sintering or in a coating method by powdering or electrostatic spraying, nor has it been obtained from a part of a pre-existing article.

The term ‘prior’ refers to a method or process which was implemented prior to step a) of the method according to the invention.

For the purposes of this patent application the term ‘rPA’ refers to a polyamide to be recycled, also known as recycled polyamide. The latter is present:
either in the form of an untransformed powder resulting from an additive manufacturing method by sintering or from a coating method by powdering or electrostatic spraying, preferably in the form of an untransformed powder resulting from an additive manufacturing method by sintering, also known as 3D printing by sintering,
or in the form of a powder obtained by grinding a polyamide-based part of an object to be recycled.

The term ‘untransformed powder resulting from additive manufacturing by sintering’ refers to the powder which has not been targeted by radiation during a prior method of additive manufacturing by sintering and which has not been used to form the object formed during the prior additive manufacturing method. Typically, this powder has spent at least 1 minute at a temperature greater than 100° C. in an additive manufacturing device.

The term ‘untransformed powder resulting from a coating method by powdering or by electrostatic spraying’ refers to the powder which has not been used to form the coating on the substrate in the prior coating method by powdering or by electrostatic spraying. Typically, this powder has been used in a process for coating a substrate by powdering or by electrostatic spraying (electrospraying).

In these two cases, the untransformed powder used as the polyamide to be recycled in the method according to the invention corresponds to a polyamide powder waste resulting from a prior process implemented earlier. The polyamide to be recycled rPA has therefore undergone degradation, generally thermal degradation.

The term ‘polyamide-based part of an object to be recycled’ refers to a part that was obtained by means of a prior transformation process, such as injection moulding, extrusion or overmoulding. The object to be recycled (or the part) may be used, broken, of poor quality and/or unfit to perform its function. The polyamide in this part is therefore also considered to be waste.

The untransformed powder, or the powder obtained by grinding a polyamide-based part of an object to be recycled, generally comprises more than 10%, typically more than 50%, or even more than 75% of polyamide (or mixture of polyamides) by weight relative to the weight of the powder. The proportion of polyamides is generally less than 99.9% by weight.

The powder is generally such that the volume median diameter (Dv50) of the particles it contains is in the range from 5 to 250 μm, in particular from 5 to 200 μm, preferably in the range from 10 to 150 μm. According to the present patent application, the ‘volume mean diameter’ or ‘Dv’ is the volume mean diameter of a pulverulent material as measured in accordance with the standard ISO 9276-parts 1 to 6: ‘Representation of results of particle size analysis’, as per the version in force in 2022. A variety of different diameters may be distinguished. More specifically, Dv50 refers to the median diameter by volume, i.e. the diameter corresponding to the 50th percentile by volume, and Dv10 and Dv90 refer respectively to the mean diameters by volume below which are situated 10 or 90% by volume of the particles. The volume mean diameter may be measured using a laser granulometer, for example a laser granulometer from Malvern Système Insitec. The associated software (RT sizer) then serves to obtain the volumetric distribution of a powder and to derive therefrom the Dv10, Dv50 and Dv90.

The polyamide rPA and the vPA may independently be a homopolyamide, a copolyamide, a copolymer with polyamide blocks and polyether blocks (polyether block amide or PEBA) or a mixture thereof. The polyamide rPA and the vPA may also independently be a mixture of polyamide and at least one other polymer, the polyamide forming the matrix, and the other polymer or polymers that form the dispersed phase.

Preferably, the polyamide rPA and the vPA are independently a condensation product of:
one or more amino acids;
one or more lactams; or
one or more salts or mixtures of diamines with diacids.

By way of example of an amino acid, mention may be made of alpha-omega amino acids, such as aminocaproic, amino-7-heptanoic, amino-11-undecanoic, n-heptyl-11-aminoundecanoic, and amino-12-dodecanoic acids.

The lactam monomers comprise, preferably, between 3 and 12 carbon atoms on the main ring and may be substituted. By way of example of lactams, mention may be made of β,β-dimethylpropriolactam, α,α-dimethylpropriolactam, amylolactam, caprolactam, capryllactam, oenantholactam, 2-pyrrolidone and lauryllactam.

Preferably the diamine used in the composition of the rPA and/or vPA polyamide is an aliphatic diamine, an aryl dimaine, and/or a saturated cyclic diamine having from 6 to 12 carbon atoms. By way of example of a diamine, mention may be made of hexamethylene diamine, decanediamine, piperazine, tetramethylene diamine, octamethylene diamine, decamethylene diamine, dodecamethylene diamine, 1,5-diamino-hexane, 2,2,4-trimethyl-1,6-diamino-hexane, diamine polyols, isophorone diamine (IPD), methyl pentamethylenediamine (MPDM), bis(aminocyclohexyl) methane (BACM), bis(3-methyl-4-aminocyclohexyl) methane (BMACM), methaxylyenediamine, bis-p-aminocyclohexylmethane, and trimethylhexamethylene diamine.

Preferably, the dicarboxylic acid used in the composition of the rPA and/or vPA polyamide has between 4 and 18 carbon atoms. By way of example of a dicarboxylic acid, mention may be made of adipic acid, sebacic acid, azelaic acid, suberic acid, isophthalic acid, butanedioic acid, 1,4-cyclohexyldicarboxylic acid and terephthalic acid, the sodium or lithium salt of sulphoisophthalic acid, dimerised fatty acids (these dimerised fatty acids have a dimer content of at least 98% and are preferably hydrogenated, and dodecanedioic acid HOOC—(CH₂)10-COOH.

Preferably, the copolyamide rPA and/or vPA results from the condensation of at least two different monomers, for example at least two different alpha-omega aminocarboxylic acids, or two different lactams, or a lactam and an alpha-omega aminocarboxylic acid having different numbers of carbon. Mention may also be made of copolyamides resulting from the condensation of at least one alpha-omega aminocarboxylic acid (or a lactam), at least one diamine, and at least one dicarboxylic acid. It is also worth mentioning the copolyamides resulting from the condensation of an aliphatic diamine with an aliphatic dicarboxylic acid and at least one other monomer that is selected from among aliphatic diamines other than the previous one and aliphatic dicarboxylic acids other than the previous one.

Preferably, the powder of polyamide rPA and/or vPA comprises at least one polyamide or copolyamide containing at least one monomer selected from among the group constituted of 4.6, 4T, 5.4, 5.9, 5.10, 5.12, 5.13, 5.14, 5.16, 5.18, 5.36, 6, 6.4, 6.9, 6.10, 6.12, 6.13, 6.14, 6.16, 6.18, 6.36, 6T, 9, 10.4, 10.9, 10.10, 10.11, 10.12, 10.13, 10.14, 10.16, 10.18, 10.36, 10T, 11, 12, 12.4, 12.9, 12.10, 12.12, 12.13, 12.14, 12.16, 12.18, 12.36, 12T, MXD6, MXD10, MXD12, MXD14, and mixtures thereof.

Preferably, the polyamide rPA and/or vPA is selected from among the group constituted of PA 6, PA 6.6, PA 10.10, PA 11, PA 12, PA 10.11, PA 6.10, PA6.12, PA 6.13 and mixtures thereof.

By way of example of copolyamides, mention may be made of copolymers of caprolactam and lauryllactam (PA 6.12); copolymers of caprolactam, adipic acid and hexamethylene diamine (PA 6. 66); copolymers of caprolactam, lauryllactam, adipic acid and hexamethylene diamine (PA 6.12.66); copolymers of caprolactam, lauryllactam, 11-aminoundecanoic acid, azelaic acid and hexamethylene diamine (PA 6. 69.11.12); copolymers of caprolactam, lauryllactam, amino-11-undecanoic acid, adipic acid and hexamethylene diamine (PA 6.66.11.12); copolymers of lauryllactam, azelaic acid and hexamethylene diamine (PA 69.12); copolymers of amino-11-undecanoic acid, terephthalic acid and decamethylene diamine (PA 11.10T).

Preferably, the average number of carbon atoms (C) relative to the nitrogen atom (N) of the polyamide rPA and/or vPA is greater than or equal to 8, in particular greater than or equal to 10, preferably greater than or equal to 11. In a particularly preferred manner, the average number of carbon atoms (C) relative to the nitrogen atom (N) of the polyamide rPA and/or vPA is 11 or 12.

Preferably, the polyamide rPA and the vPA are independently selected from among PA 11, PA 10.10, PA 10.12, PA 12, PA 12.12, PA 10.14 or PA 12.14 and mixtures thereof, preferably from PA11 or PA12 or a mixture thereof.

The nomenclature used to define polyamides is as described in the standard ISO 1874-1:2010 ‘Plastics-Polyamide (PA) moulding and extrusion materials-Part 1: Designation system and basis for specification’, in particular on page 3 (Tables 1 and 2) and is well known to the person skilled in the art.

Preferably, the polyamide of the polyamide rPA and the polyamide vPA are identical in nature. For example, the virgin polyamide is vPA11, the polyamide to be recycled rPA is an rPA11. According to another example, the virgin polyamide is vPA12 and the polyamide to be recycled rPA is an rPA12.

The virgin polyamide vPA generally has an inherent viscosity that is lower than or equal to 1.50, in particular lower than or equal to 1.40, preferably lower than or equal to 1.30. For the purposes of the patent application, the inherent viscosity is as measured using an Ubbelohde tube at 20° C. on a 0.5% by weight solution in m-cresol according to the standard ISO 307 of 2019.

Generally, the inherent viscosity of the virgin polyamide vPA is lower than that of the powder of the mixture, typically the inherent viscosity of the virgin polyamide vPA is at least 10%, in particular at least 20%, preferably at least 30%, lower than that of the powder of the mixture.

The powder of the mixture generally has an inherent viscosity that is greater than or equal to 1.50, preferably greater than or equal to 1.60, and more often of the order of 1.70 to 5.00.

Generally, the polydispersity index of molecular weight distribution (molecular weight-polydispersity index) Ip of the virgin polyamide vPA is lower than that of the polyamide to be recycled rPA. Typically, the polydispersity index Ip of the virgin polyamide vPA is lower by at least 20%, in particular by at least 35%, preferably by at least 50%, relative to the polydispersity index Ip of the polyamide to be recycled rPA. The molecular weight-polydispersity index Ip is the ratio of the weight-average molecular weight Mw to the number-average molecular weight Mn.

Preferably, the molecular weight-polydispersity index Ip of the virgin polyamide vPA is from 1.6 to 2.2, in particular from 1.6 to 2.1, and/or the molecular weight-polydispersity index Ip of the polyamide to be recycled rPA is from 2.5 to 15.0, in particular from 2.8 to 10.0.

Generally, the polydispersity index in terms of z-average, Iz, of the virgin polyamide vPA, is lower than that of the polyamide to be recycled, rPA. Typically, the polydispersity index Iz of the virgin polyamide vPA is lower by at least 30%, in particular by at least 50%, preferably by at least 70%, relative to the polydispersity index Iz of the polyamide to be recycled rPA. The z-average polydispersity index Iz is the ratio of the z-average molecular weight Mz to the number-average molecular weight Mn.

Preferably, the z average-polydispersity index Iz of the virgin polyamide vPA is from 1.5 to 3.5, in particular from 2.0 to 3.0, and/or the z average-polydispersity index Iz of the polyamide to be recycled rPA is from 3.5 to 50.0, in particular from 4.0 to 30.0.

The number average molecular weights Mn, weight average molecular weights Mw, and z average molecular weights Mz are measured by steric exclusion chromatography (or gel permeation chromatography) in accordance with the standard ISO 16014-1 of 2012. Typically, the polyamide is solubilised in hexafluoroisoproponol stabilised with 0.05 M potassium trifluoroacetate for a period of 24 h at ambient temperature (20° C.) at a concentration of 1 g/L. The solution obtained is then filtered on a polytetrafluoroethylene (PTFE) membrane with a pore size of 0.2 μm, and subsequently injected at a flow rate of 1 mL/min into a liquid chromatography system equipped with a set of PFG columns from Polymer Standards Service consisting of a pre-column with dimensions of 50×8 mm; a 1000 Å column with dimensions of 300×8 mm and particle size of 7 μm; and a 100 Å column with dimensions of 300×8 mm and particle size of 7 μm, with dimensions of 300×8 mm and a particle size of 7 μm, and a 100 Å column with dimensions of 300×8 mm and a particle size of 7 μm. The molar masses are measured by refractive index and are expressed in PMMA equivalents, used as a calibration standard, and are subsequently converted into g/mol.

The polyamides to be recycled rPA present some particularities, and in particular new species resulting from oxidation mechanisms.

The term ‘new species resulting from oxidation mechanisms,’ for the purposes of the invention, is used to refer to primary amide functions, nitriles, terminal methyl groups, alkenes, formamides, imides, carboxylic acids and alcohols that may appear in the polyamide to be recycled rPA in the context the invention.

The polyamide to be recycled rPA in the context the invention contains functional groups resulting from oxidation reactions selected from among primary amide functional groups, nitriles, terminal methyl groups, alkenes, formamides, imides, carboxylic acids and alcohols.

According to one preferred embodiment of the invention, the polyamide to be recycled rPA in the context the invention contains functional groups resulting from oxidation reactions selected from among nitriles and terminal methyl groups in a molar ratio to secondary amide functional groups that is greater than that of the same virgin polyamide, and primary amine functional groups in a molar ratio to secondary amide functional groups that is lower than that of the same virgin polyamide.

These functional groups may be identified and quantified by means of infrared spectroscopy and/or proton or carbon NMR.

The NMR measurements may be carried out in the hexafluoroisopropanol (HFIP)/CD₂Cl₂ mixture. For example, 20 mg of polymer may be dissolved in 0.7 mL of solvent with a HFIP/CD₂Cl₂ ratio of 1/3. The mixture dichloromethane (CD₂Cl₂)/trifluoroacetic anhydride (TFAA) may also be used.

This method is described in the doctoral thesis by E. Goncalves in chapter 11.2.3 published in 2011, incorporated by reference. Analyses in these two solvents provide the means to identify the majority of functional groups formed over the life of the polyamide.

Thus, by way of example, in infrared spectroscopy, the absorption band from 1700 to 1740 cm⁻¹ corresponds to an imide, the band from 1680 to 1720 cm⁻¹ corresponds to the carbonyl of the carboxylic acid, and the band from 3580 to 3670 cm⁻¹ corresponds to the alcohol function of the carboxylic acid.

The absorption band from 3580 to 3670 cm⁻¹ corresponds to the free alcohol functional group.

The amide functional group is characterised on the one hand, by a pair of absorption bands from 3100 to 3500 cm⁻¹ and from 15560 to 1640 cm⁻¹ which correspond to the NH group of the amide, and on the other hand, by the absorption band from 1650 to 1700 cm⁻¹ which corresponds to the carbonyl group of the amide.

The absorption bands of 1180 and 1723 cm⁻¹ correspond to formates. The bands at 900 and 1660 cm⁻¹ correspond to alkenes.

The NMR quantification is carried out, for example, by comparing the intensity of the lines of the functional groups not present in the virgin polymer with the lines corresponding to the α-CH₂ of the functional groups amides, ethers or other CH₂s in the context of proton NMR. In carbon NMR, the intensity of the lines of the functional groups formed over the life of the polymer is compared to the intensity of the lines of the carbons of the amides or of CH₂.

Certain of the functional groups mentioned above may be observed, for example, in 13C NMR in the solvent HFIP/CD₂Cl₂. Thus the line at 36 ppm corresponds to the α-CH₂ of the primary amide, the line at 34 ppm corresponds to the α-CH₂ of the carboxylic acid. These species may be quantified by integrating the area under the lines and comparing them with the area under the 37.1 ppm line corresponding to the secondary amide. In a similar fashion, the lines corresponding to the carbonyl groups of the functional groups primary amides, carboxylic acids and secondary amides are observed at 181.2 ppm, 179.6 ppm and 177.4 ppm respectively. The line at 16.7 ppm corresponds to the α-CH₂ of the nitrile group. The formamide group gives a chemical shift at 163.0 ppm and 166.3 ppm.

Other functional groups mentioned above may be observed by proton NMR (1H NMR) in the HFIP/CD₂Cl₂ solvent as described above. The line of the CHO groups of the formamides emerges at 7.92 and 8.01 ppm. The line corresponding to the α-CH₂ groups of the primary amides may be observed at 2.30 ppm. The line at 0.9 ppm corresponds to the CH₃ groups of the CH₃—(CH₂)ₙ type. The line at 2.40 ppm corresponds to the α-CH₂ of the nitrile functional group. The line corresponding to the proton of the formate functional group is observed at 8.1 ppm. The line corresponding to the proton of the aldehyde functional group was observed at 9.7 ppm. In a similar manner to that which is described for carbon NMR, the ratios of new functional groups to secondary amides may be determined by integrating the area under the lines and comparing them to the area under the line corresponding to the α-CH₂ of the secondary amide (2.20 ppm) or to the area under the line corresponding to the CONH proton of the secondary amide (6.0-6.1 ppm).

According to any one of the embodiments of the invention, in a polyamide to be recycled rPA in the context the invention, the molar ratio of the functional groups resulting from oxidation reactions to the secondary amide functional groups is between 0.0005 and 0.3.

According to any one of the embodiments of the invention, in a polyamide to be recycled rPA in the context the invention, the molar ratio of the imide functional groups to the secondary amide functional groups is between 0.0005 and 0.1, in particular between 0.001 and 0.08, in particular between 0.005 and 0.05.

According to any one of the embodiments of the invention, in a polyamide to be recycled rPA in the context the invention, the molar ratio of the carboxylic acid functional groups to the secondary amide functional groups is between 0.0005 and 0.1, in particular between 0.001 and 0.08, in particular between 0.005 and 0.05.

According to any one of the embodiments of the invention, in a polyamide to be recycled rPA in the context the invention, the molar ratio of the alcohol functional groups to the secondary amide functional groups is between 0.0005 and 0.1, in particular between 0.001 and 0.08, in particular between 0.005 and 0.05.

According to any one of the embodiments of the invention, in a polyamide to be recycled rPA in the context the invention, the molar ratio of the primary amide functional groups to the secondary amide functional groups is between 0.0005 and 0.1, in particular between 0.001 and 0.08, in particular between 0.005 and 0.05.

According to any one of the embodiments of the invention, in a polyamide to be recycled rPA in the context the invention, the molar ratio of the nitrile functional groups to the secondary amide functional groups is between 0.0005 and 0.1, in particular between 0.001 and 0.08, in particular between 0.005 and 0.05.

According to any one of the embodiments of the invention, in a polyamide to be recycled rPA in the context the invention, the molar ratio of the alkene functional groups to the secondary amide functional groups is between 0.0005 and 0.1, in particular between 0.001 and 0.08, in particular between 0.005 and 0.05.

According to any one of the embodiments of the invention, in a polyamide to be recycled rPA in the context the invention, the molar ratio of the formamide functional groups to the secondary amide functional groups is between 0.0005 and 0.1, in particular between 0.001 and 0.08, in particular between 0.005 and 0.05.

According to any one of the embodiments of the invention, in a polyamide to be recycled rPA in the context the invention, the molar ratio of the terminal methyl functional groups to the secondary amide functional groups is between 0.0005 and 0, 2, in particular between 0.001 and 0.08, in particular between 0.005 and 0.05.

It is obvious that, depending on the wastes and the exposure to which they have been subjected, one or more functional groups resulting from oxidation reactions may be present.

The mixture in step a) comprises:
from 5 to 90% by weight, generally from 5 to 70% by weight, in particular from 20 to 65% by weight, preferably from 40 to 60% by weight, of virgin polyamide vPA;
from 10 to 95% by weight, generally from 30 to 95% by weight, in particular from 35 to 80% by weight, preferably from 40 to 60% by weight, of polyamide to be recycled rPA;
relative to the total weight of the mixture.

The mixture in step a) may comprise compounds/components other than the virgin polyamide vPA or the polyamide to be recycled rPA.

The mixture in step a) may comprise a chain-limiting agent that contains at least one, preferably at least two functional groups, each selected independently from among carboxylic acids and amines. This embodiment is particularly preferred when the proportion of polyamide to be recycled rPA within the mixture is greater than 50% by weight.

This chain-limiting agent may be a carboxylic diacid, a diamine or an amino acid. It serves to enable reacting with the amide-, amine- or carboxylic acid functional groups of the rPA and/or vPA during kneading of the mixture in the molten state (melt kneading) and to reduce the inherent viscosity of the polyamide composition obtained by the method.

The amino acid may be selected from among aminocaproic acid, 7-amino-heptanoic acid, 11-amino-undecanoic acid, 12-aminododecanoic acid, and/or mixtures thereof.

In order to ensure good properties (flexibility, bursting strength/burst resistance, tear strength, rheology, alloy morphology, compatibilisation, homogeneity, consistency, adhesion) and, in particular, good properties of impact/shock resistance and impact resistance after ageing (in particular thermo-oxidative ageing at high temperatures), it is possible to add to the mixture an impact modifier, in particular one that is elastomeric and preferably polar in nature.

Thus, the mixture may comprise up to 20% by weight, relative to the total weight of the mixture, of an impact modifier constituted of a non-rigid polymer having a flexural modulus of less than 100 MPa as measured in accordance with the standard ISO 178 of 2010.

This non-rigid polymer is preferably as flexible as possible and has the lowest possible glass transition temperature Tg, that is to say below 0° C. Where necessary, this impact modifier is chemically functionalised so as to be able to react with the polyamide and form an alloy that is compatible therewith.

The impact modifier is preferably composed of one or more polyolefins, with a part or the entirety thereof carrying a functional group selected from among carboxylic acid, carboxylic acid anhydride, epoxide, and any other functional group that is capable of reacting chemically with the polyamides, typically with its amine chain ends (in the case of carboxylic acid, maleic anhydride) or its acid chain ends (in the case of epoxide, in particular glycidyl methacrylate). For example, the polyolefin is selected from among: an ethylene-propylene copolymer that is elastomeric in nature (EPR), an ethylene-butene copolymer, an ethylene-octene copolymer, an ethylene-propylene-diene copolymer that is elastomeric in nature (EPDM) and an ethylene/alkyl (meth)acrylate copolymer, for example anhydride-grafted EPR such as Exxelor VA1803 from Exxon, or a copolymer of polyethylene, ethyl acrylate and maleic anhydride (coPE/EA/MAH) such as Lotader 4700 from the company SK.

The mixture may also include polyamide additives, such as: pigments, dyes, light stabilisers (UV) and/or heat stabilisers, plasticisers, surfactants, optical brighteners, antioxidants, natural waxes, mould release agents, fillers, reinforcing fibres, or mixtures thereof.

The fillers envisaged include mineral fillers, such as those selected from among the group, provided without limitation, comprising talc, kaolin, magnesia, slag, silica, carbon black, carbon nanotubes, expanded or unexpanded graphite, titanium oxide.

The reinforcing fibres are selected from fibres, particularly short fibres. The fibres may be of synthetic origin, in particular glass or carbon fibres, or of natural origin, typically derived from plants such as fibres of flax, reed, bamboo or hemp.

The usual stabilisers used with polymers are phenols, phosphites, UV absorbers, stabilisers of the HALS (Hindered Amine Light Stabiliser) type, metal iodides, or thioethers. Examples that may be mentioned are Irganox 1010, 245, 1098, Irgafos 168, 126, Tinuvin 312, 770, Iodide P201 from the company Ciba, Nylostab S-EED from the company Clariant, AO 412S from the company Adeka Palmarole.

Preferably, the additives in the mixture may be present in a quantity that is less than or equal to 10%, and more particularly less than 5% by weight relative to the weight of the mixture.

The sum of the virgin polyamide vPa and the powder comprising the polyamide to be recycled rPa generally represents at least 40% by weight, in particular at least 60% by weight, or even at least 80% by weight of the mixture, and occasionally at least 95% of the mixture, or indeed even 100% of the mixture.

Preferably, the mixture is free of any crystallising agent (such as an inorganic salt of an organic acid, for example sodium-, potassium- or calcium benzoate) and/or lubricating agent (such as a zinc-, calcium- or magnesium stearate).

Preferably, the mixture is free of H₃PO₂ and/or H₃PO₃. For the purposes of this patent application, H₃PO₂ and H₃PO₃ are not considered to be additives. The recycled untransformed powders resulting from additive manufacturing by sintering offer the advantage of containing few, if any, phosphine-forming precursor species, unlike the virgin polyamide powders. This advantage provides the ability to transform (by extrusion, injection in particular) the recycled 3D powders in a safer manner than the powders of virgin polyamides.

In one embodiment, the mixture is constituted of a mixture of:
from 5 to 70% by weight, in particular from 20 to 65% by weight, preferably from 40 to 60% by weight, of a virgin polyamide vPA;
from 30 to 95% by weight, in particular from 35 to 80% by weight, preferably from 40 to 60% by weight, of a polyamide to be recycled rPA;
from 0 to 4% by weight, in particular between 0.01 to 4% by weight, preferably from 0.1 to 1%, advantageously from 0.2 to 0.8% of a chain limiting agent, in particular as defined above;
from 0 to 20% by weight, in particular 0 to 10% by weight of an impact modifier, in particular as defined above; and
from 0 to 10% by weight, in particular 0 to 5% by weight of additives, in particular as defined above;
relative to the total weight of the mixture.

The method comprises a step b) of kneading the said mixture in the molten state (melt kneading), as a result of which a polyamide composition is obtained.

The composition according to the invention is particularly simple to prepare since it is sufficient to carry out the kneading in the molten state of a mixture of the vPA and the rPA.

Typically, the temperature during kneading is at least 5° C. higher, preferably at least 10° C. higher, than the highest melting temperature among the melting temperatures of the vPA and the rPA. This temperature must generally remain below 330° C. in order to avoid thermal degradation of the polyamides.

Typically, the temperature during kneading is higher than 200° C. and lower than 330° C., preferably higher than 220° C. and lower than 320° C., for example between 220° C. and 310° C., or for example between 230° C. and 300° C.

Generally, the residence time of the mixture during kneading is less than 10 minutes, in particular less than 5 minutes, or less than 3 minutes, or even less than that.

This method of kneading in the molten state is carried out preferably in a single-screw, co-rotating twin-screw system or co-kneader such as the BUSS kneader.

The method comprises a step c) of recovering the polyamide composition obtained after the kneading in the molten state. The recovery step c) may be carried out using methods known to the person skilled in the art.

This step generally comprises the extrusion of the polyamide composition obtained following kneading in the molten state.

The extrusion may be carried out in a high shear mixer such as a single or twin screw extruder.

The extrusion may be carried out through a pelletising die in order to produce pellets. The volume median diameter Dv50 of the pellets is advantageously within a range from 1 to 10 mm and in particular from 2 to 4 mm. Alternatively, the extrusion may be carried out through a die to a cooled rolling mill in which the mixture solidifies, or indeed by means of a calender. Thereafter, the solidified mixture may be fed to a crusher in order to produce chips. These chips typically have an average size of 5×5×1 mm.

Typically, the recovery step consists of an extrusion step, a cooling step of cooling the composition in the molten state using a cooling liquid generally containing water, a cutting step of cutting the composition in the form of pellets, and a separation step of separating the cooling liquid from the cooled composition.

The cutting step may be carried out during the cooling step, or after the cooling step, and before the separation step or after the separation step.

The recovery step may be followed by a grinding step in order to obtain the composition in the form of chips or powder.

These forms are suitable for subsequently undergoing further forming or shaping by extrusion, injection or overmoulding.

The method may be a batch process.

The method may be a continuous process.

According to a second object, the invention relates to a polyamide composition that is obtainable by the method described above.

The embodiments described above, in particular for the mixture and its constituents and the proportions thereof, and the form of the composition obtained, are most certainly applicable, since the polyamide composition is obtainable by the method described above.

Advantageously, the composition according to the invention has an elongation at break as measured in accordance with the standard ISO 527 1A of 2019, that is more favourable as compared to that of a composition which is identical except for the fact that the polyamide to be recycled rPA is replaced by a virgin polyamide vPA (i.e. as compared to a composition free from rPA).

Advantageously, the composition according to the invention has greater cold impact resistance as compared to a composition which is identical except for the fact that the polyamide to be recycled rPA is replaced by a virgin polyamide vPA (i.e. as compared to a composition free from rPA. The cold impact resistance is advantageously augmented by at least 10%, preferably by at least 30%, in particular by at least 50%. The impact resistance may be determined in accordance with the standard ISO 179-1eA of 2010.

Advantageously, in the molten state, the composition according to the invention has better rheological properties at representative frequencies of implementation (for example at an angular frequency between 5 and 500 rad/s) by extrusion, injection or overmoulding as compared to a composition which is identical except for the fact that the polyamide to be recycled rPA is replaced by a virgin polyamide vPA (i.e. as compared to a composition free from rPA), which is an advantage for the forming and shaping of the composition by extrusion or injection.

Without intending to be tied to any particular theories, the powder form polyamide to be recycled rPA generally has a higher molecular weight and a higher polydispersity index Iz (Mz/Mn) and/or Ip (Mw/Mn) than the virgin polyamide vPA of identical nature. For example, rPA11 generally has a higher molecular weight and a higher polydispersity index Iz (Mz/Mn) and/or Ip (Mw/Mn) than vPA11. Consequently, this makes it possible, when the powder is additivated into a virgin polyamide grade, to both increase the cold impact strength and the elongation at break of the articles (as compared to an article free of rPA).

This also makes it possible to improve the processability/operational implementation of the composition according to the invention. In fact, the higher polydispersity index Iz (Mz/Mn) of the polyamide composition according to the invention as compared to that of the virgin polyamide vPA makes it possible to enhance the melt strength (the melt being the composition in molten state) during extrusion, moulding or overmoulding in order to form an article or part.

In addition, the rPA has more oxidised functional groups than the vPA, and therefore more polar groups. The addition of rPA into a grade of vPA confers better adhesion properties and thus facilitates the operational implementation of the composition according to the invention by overmoulding. The improvement in adhesion properties can, for example, be empirically evidenced by a peel test at the interface of two parts that have been combined by overmoulding.

In fact, during the additive manufacturing method, new species resulting from oxidation mechanisms, in particular functional groups resulting from the degradation of primary amides and/or alpha methylene of the said amide functional groups, such as primary amide functional groups, nitriles, terminal methyl groups (CH₃(CH₂)ₙ, alkenes (CH₂═CH—), formamides, imides, carboxylic acids and alcohols, appear in the polyamide structure. These functional groups are described above.

Infrared can be used to detect the presence or absence of these new species resulting from oxidation mechanisms.

Thus the absorption band: from 1700 to 1740 cm⁻¹ corresponds to an imide; from 1680 to 1720 cm⁻¹ corresponds to the carbonyl of the carboxylic acid; and from 3580 to 3670 cm⁻¹ corresponds to the alcohol functional group of the carboxylic acid.

The absorption band from 3580 to 3670 cm⁻¹ corresponds to the free alcohol functional group.

The amide functional group is characterised on the one hand by a pair of absorption bands from 3100 to 3500 cm⁻¹ and from 1560 to 1640 cm⁻¹ which correspond to the NH group of the amide, and on the other hand by the absorption band from 1650 to 1700 cm⁻¹ which corresponds to the carbonyl group of the amide.

The quantification of the said new species resulting from the oxidation mechanisms is carried out by proton NMR in dichloromethane-d², with the adding of HFIP (hexafluoroisopropanol) in order to solubilise the polyamide.

For example, 20 mg of polymer may be dissolved in 0.7 mL of solvent with an HFIP/CD₂Cl₂ ratio of 1/3.

Certain of the functional groups mentioned below can be observed, for example, in 13C NMR. Thus the line at 36 ppm corresponds to the α-CH₂ of the primary amide, and the line at 34 ppm corresponds to the α-CH₂ of the carboxylic acid. These species may be quantified by integrating the area under the lines and comparing them with the area under the 37.1 ppm line corresponding to the secondary amide.

In similar fashion, the lines corresponding to the carbonyl groups of the functional groups: primary amides, carboxylic acids and secondary amides, are observed at 181.2 ppm, 179.6 ppm and 177.4 ppm respectively.
The line at 16.7 ppm corresponds to the α-CH₂ of the nitrile group.
The formamide group gives a chemical shift at 163.0 ppm and 166.3 ppm.
Other functional groups mentioned above may be observed by proton NMR (1H NMR) in the HFIP/CD₂Cl₂ solvent as described above. The line of the CHO groups of the formamides emerges at 7.92 and 8.01 ppm. The line corresponding to the α-CH₂ groups of the primary amides may be observed at 2.30 ppm. The line at 0.9 ppm corresponds to the CH₃ groups of the CH₃—(CH₂)ₙ type. The line at 2.40 ppm corresponds to the α-CH₂ of the nitrile functional group. In a similar manner to that which is described for carbon NMR, the ratios of new functional groups to secondary amides may be determined by integrating the area under the lines and comparing them to the area under the line corresponding to the α-CH₂ of the secondary amide (2.20 ppm).

Preferably, the inherent viscosity of the polyamide composition according to the invention is lower by at least 10%, in particular by at least 20%, preferably by at least 30%, as compared to that of the powder of the mixture used in step a).

Preferably, when the average number of carbon atoms (C) relative to the nitrogen atom (N) of the polyamide rPA and vPA is greater than or equal to 8, in particular greater than or equal to 10, preferably greater than or equal to 11, in particular when the virgin polyamide and the polyamide to be recycled used as starting materials in the mixture are independently PA11 or PA12, the inherent viscosity of the polyamide composition according to the invention is lower than or equal to 1.50, preferably lower than or equal to 1.40, 1.30, 1.25, 1.20, 1.15, or even lower than or equal to 1.10. For example, the inherent viscosity of the polyamide composition may be between 0.80 and 1.50, preferably between 0.90 and 1.40, between 0.90 and 1.30, between 0.90 and 1.20 (limits inclusive).

Preferably, when the average number of carbon atoms (C) relative to the nitrogen atom (N) of the polyamide rPA and vPA is greater than or equal to 8, in particular greater than or equal to 10, preferably greater than or equal to 11; in particular when the virgin polyamide and the polyamide to be recycled used as starting materials in the mixture are independently of PA11 or PA12, the ‘melt flow index’ MFI or ‘melt flow rate’ MFR (as per the accepted terminology) of the composition according to the invention, as measured at 235° C., under 2.16 kg, is between 0.1 and 60 cm³/10 min, advantageously between 0.2 and 45 cm³/10 mins. Preferably, the fluidity index of the composition according to the invention as measured according to the standard ISO 1133 at 250° C. under a weight of 5 kg is greater than 30, advantageously greater than 40, in particular greater than 50, and preferably greater than 60 cm³/10 min.

Generally, the z average-polydispersity index Iz of the polyamides of the composition according to the invention is higher than that of the virgin polyamide used as starting material in the mixture, and/or the molecular weight-polydispersity index Ip of the polyamides of the composition is higher than that of the virgin polyamide used as starting material in the mixture.

Preferably, the z average-polydispersity index Iz (Mz/Mn) of the polyamides of the composition according to the invention is greater than or equal to 3.0, typically greater than or equal to 3.5, in particular greater than or equal to 4.0, preferably greater than or equal to 5.0; and/or the molecular weight-polydispersity index Ip (Mw/Mn) of the polyamides of the composition is greater than or equal to 1.5, typically greater than 2.0, in particular greater than or equal to 2.5, preferably greater than 3.0, indeed even greater than 4.0. Generally, the z average-polydispersity index Iz is lower than 30.0, in particular lower than 25.0, preferably lower than 15.0; and/or the molecular weight-polydispersity index Ip is lower than 20.0, in particular lower than 15.0, preferably lower than 8.0, in a particularly preferred manner lower than 7.0.

According to a third object, the invention relates to an article preparation method for preparing an article that comprises a step of extrusion, moulding or overmoulding of the composition according to the invention, as a result of which an article is obtained.

According to a fourth object, the invention relates to an article preparation method for preparing an article which comprises the steps of:
a) providing a mixture comprising:
from 5 to 90% by weight of a virgin polyamide vPA;
from 10 to 95% by weight of a polyamide to be recycled rPA;
relative to the total weight of the mixture;
the polyamide to be recycled rPA being in the form of an untransformed powder resulting from additive manufacturing by sintering or from a coating method by powdering or by electrostatic spraying;
b) kneading the said mixture in the molten state (melt kneading), as a result of which a polyamide composition is obtained;
c) recovering the said polyamide composition;
d) extrusion, moulding or overmoulding of the recovered composition, as a result of which an article is obtained.

According to a fifth object, the invention relates to an article that is obtainable by the above method.

The article is preferably a formed-shaped article that comprises the composition as defined above, such as fibre, fabric, film, sheet, rod, tube, extruded part, and injected part. Thus, the composition according to the present invention is advantageous for the manufacture of articles, in particular sports articles or component elements of sports articles, which must in particular exhibit both good impact resistance and good endurance when subjected to the ravages of mechanical, chemical, UV and thermal stresses. Among these sports articles, mention may be made of component elements of sports footwear, sports apparatus and equipment such as ice skates or other winter sports and mountaineering articles, ski bindings, snowshoes, sports bats, boards, horseshoes, flippers, golf balls and leisure/recreational vehicles, in particular those designed for cold weather activities. In general terms, mention may be made of leisure and DIY/home improvement articles, tools and equipment for roadworks that are subject to the ravages of the climatic and mechanical stresses, personal protection articles, such as helmet visors, eyewear and eyewear temples. Mention may also be made, by way of non-limiting examples, of component elements of cars, such as headlight guards; rear-view mirrors; small parts for all-terrain/off-road vehicles; fuel tanks, in particular those for mopeds, motorbikes and scooters, which are subject to the ravages of mechanical and chemical stresses, screws and bolts, cosmetic articles subject to the ravages of mechanical and chemical stresses, lip colour sticks, pressure gauges and aesthetic protection component elements such as gas cylinders. Mention should also be made of objects or parts of objects used in the electronics industry that require adherence to dimensional specifications, for example parts for mobile phones, computers, tablets, etc.

Advantageously, the article according to the invention generally exhibits lower exudation as compared to an article prepared from a composition in which the polyamide to be recycled rPA is replaced by the virgin polyamide vPA (therefore as compared to a composition free of rPA11 or rPA12). Typically, exudation is determined on 1 mm plates that are placed for 7 days at 70° C. and 62% RH (relative humidity). Exudation is manifested by the appearance of a deposit on the surface and is estimated visually.

Without intending to be tied to any particular theories, the increase in the molar masses of the polyamide chains of the powder wastes would imply a lower proportion of oligomers in the latter. However, these oligomers are generally responsible for the exudation. The article according to the invention thus exhibits an exudation that is lower than that of an article obtained from exclusively virgin polyamide.

The invention is illustrated with the FIGURE and the examples that follow, which are provided on a non-limiting basis.

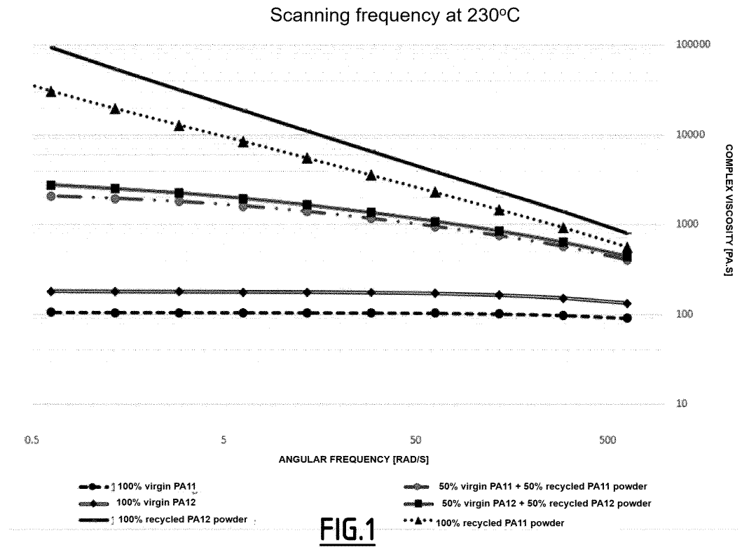

FIG. 1 represents the rheology curves of: the virgin PA 11 (vPA11), virgin PA 12 (vPA12), an untransformed PA11 powder to be recycled (rPA11) resulting from additive manufacturing by sintering, an untransformed PA12 powder to be recycled (rPA12) resulting from additive manufacturing by sintering, a composition obtained by hot kneading of 50% by weight of vPA11 and 50% by weight of vPA11 powder, and a composition obtained by hot kneading of 50% by weight of vPA12 and 50% by weight of vPA12 powder.

### EXAMPLES

### Example 1: Rheology of Compositions According to the Invention

For two types of homopolymeric PA (PA11 (with inherent viscosity of 1.0 and supplied by Arkema) and PA12 (with inherent viscosity of 1.0 and supplied by Arkema)) the rheology of the polyamides in the molten state (polyamide melts) used as starting materials in the mixture (virgin PA and an untransformed PA powder to be recycled resulting from additive manufacturing by sintering). These polyamides, mixed with a proportion of 50% by weight of vPA and 50% by weight of rPA relative to the weight of the mixture, were then kneaded in the molten state (melt-kneaded) in accordance with the method according to the invention in order to form two compositions of polyamides.

The rheology curves are as illustrated in FIG. 1.

The capillary rheology analyses show that, at frequencies representative of the operational implementation by extrusion or injection, the two compositions according to the invention exhibit better melt strength than the virgin polyamides vPA, which is an advantage for the process of forming and shaping of the composition by extrusion or injection.

### Example 2: Inherent Viscosity, Polydispersity Index Ip and Iz of a Composition Based on vPA11 and rPA11 According to the Invention

A virgin vPA11 and an untransformed rPA11 powder to be recycled resulting from additive manufacturing by sintering, were mixed with a proportion of 50% by weight of vPA11 and 50% by weight of rPA relative to the weight of the mixture, and were then melt-kneaded in accordance with the method according to the invention in order to form a polyamide composition.

It proved to be impossible to operationally implement the rPA11 powder by injection moulding. The inherent viscosity of the rPA11 being too high (broad Ip and Iz), the mixture was too viscous to be used in injection moulding and did not properly fill the moulds, thus resulting in parts having defects and poor surface appearance. By contrast, the composition obtained by kneading was able to be injected without difficulty.

Table 1 below provides the inherent viscosities and polydispersity indices Ip and Iz of the starting materials and the composition according to the invention.

TABLE 1

| | | | Virgin PA11 + | |
|---|---|---|---|---|
| | | | 50% PA11 3D | 100% PA11 |
| | | Virgin | Powder to be | 3D Powder to |
| | Method | PA11 | recycled | be recycled |
| Modulus (Mpa) | ISO 527 1A (2019) | 1437 | 1432 | Difficulties during |
| Nominal | ISO 527 1A (2019) | 114 | 252 | operational |
| Elongation | | | | implementation due |
| at Break (%) | | | | to extremely high |
| Strain at Break | ISO 527 1A (2019) | 33.4 | 45.5 | inherent viscosity |
| (Mpa) | | | | |
| Charpy V-notch | ISO 179 1eA (2010) | 8 | 8 | |
| Impact at 23° C. | | | | |
| (Kj/m²) | | | | |
| Charpy V-notch | ISO 79 1eA (2010) | 9 | 12 | |
| Impact at −30° C. | | | | |
| (Kj/m²) | | | | |
| Inherent | according to the | 1.01 | 1.07 | 2.75 |
| Viscosity | standard ISO 307* | | | |
| | (2019) | | | |
| Ip = Mw/Mn | calculated based on | 1.8 | 3.0 | 8.4 |
| | Mw and Mn measured | | | |
| | according to ISO | | | |
| | 16014-1 (2012) | | | |
| Iz = Mz/Mn | calculated based on | 2.7 | 5.9 | 24.4 |
| | Mz and Mn measured | | | |
| | according to ISO | | | |
| | 16014-1 (2012) | | | |

*As measured using an Ubbelohde tube at 20° C. on a 0.5% by weight solution in m-cresol excepting the fact that the measurement temperature is 20° C. instead of 25° C.

The inherent viscosities and polydispersity indices Ip and Iz of the starting materials and the composition according to the invention.

### Example 3: Inherent Viscosity, Polydispersity Indices Ip and Iz of a Composition Based on vPA12 and rPA12 According to the Invention

A virgin vPA12 and an untransformed rPA12 powder to be recycled resulting from additive manufacturing by sintering were mixed with a proportion of 70% by weight of vPA12 and 30% by weight of rPA12 relative to the weight of the mixture, and subsequently were melt-kneaded in accordance with the method according to the invention in order to form a polyamide composition.

It proved to be impossible to operationally implement the rPA12 powder by injection moulding. The inherent viscosity of the rPA12 being too high (broad Ip and Iz), the mixture was too viscous to be used in injection moulding and did not properly fill the moulds, thus resulting in parts having defects and poor surface appearance. By contrast, the composition obtained by kneading was able to be injected without difficulty.

Table 2 below provides the inherent viscosities and polydispersity indices Ip and Iz of the starting materials and the composition according to the invention.

TABLE 2

| | | | Virgin PA12 + | |
|---|---|---|---|---|
| | | | 30% PA12 3D | 100% PA12 |
| | | Virgin PA 12 | Powder to | 3D Powder |
| | Method | (comparative) | be recycled | to be recycled |
| Modulus (Mpa) | ISO 527 1A (2019) | 1123 | 1130 | Difficulties during |
| Nominal | ISO 527 1A (2019) | 104 | 153 | operational |
| Elongation | | | | implementation due |
| at Break (%) | | | | to extremely high |
| Strain at Break | ISO 527 1A (2019) | 37 | 44 | inherent viscosity |
| (Mpa) | | | | |
| Charpy V-notch | ISO 179 1eA (2010) | 5 | 7 | |
| Impact at 23° C. | | | | |
| (Kj/m²) | | | | |
| Charpy V-notch | ISO 179 1eA (2010) | 6 | 8 | |
| Impact at −30° C. | | | | |
| (Kj/m²) | | | | |
| Inherent | according to the | 0.99 | 1.07 | 2.70 |
| Viscosity | standard ISO 307* | | | |
| | (2019) | | | |
| Ip = Mw/Mn | calculated based on | 1.7 | 2.7 | 7.9 |
| | Mw and Mn measured | | | |
| | according to ISO | | | |
| | 16014-1 (2012) | | | |
| Iz = Mz/Mn | calculated based on | 2.6 | 4.6 | 23.8 |
| | Mz and Mn measured | | | |
| | according to ISO | | | |
| | 16014-1 (2012) | | | |

*As measured using an Ubbelohde tube at 20° C. on a 0.5% by weight solution in m-cresol excepting the fact that the measurement temperature is 20° C. instead of 25° C. The inherent viscosities and polydispersity indices Ip and Iz of the starting materials and the composition according to the invention.

### Example 4: Impact of the Content of Chain Limiting Agent in a Composition Based on vPA11 and rPA11 According to the Invention

Adipic acid was used by way of a chain limiting agent.

A virgin vPA11 and an untransformed rPA11 powder to be recycled resulting from additive manufacturing by sintering were mixed with a proportion of:
either 70% by weight of vPA11 and 30% by weight of rPA11 relative to the weight of the mixture;
or 28.8% by weight of vPA11 and 70% by weight of rPA11 and 1.2% of adipic acid relative to the weight of the mixture;
or 29.4% by weight of vPA11 and 70% by weight of rPA11 and 0.6% of adipic acid relative to the weight of the mixture;
or 29.8% by weight of vPA11 and 70% by weight of rPA11 and 0.2% of adipic acid relative to the weight of the mixture;
and subsequently were melt-kneaded in accordance with the method according to the invention in order to form a polyamide composition.

The compositions obtained by kneading were able to be injected without difficulty.

Table 3 below provides the inherent viscosities and polydispersity indices Ip and Iz of the virgin PA11 used as starting material and of the compositions according to the invention. The properties of rPA11 and vPA11 used as starting materials are indicated in Table 1 above.

TABLE 3

| | | Virgin PA11 + | Virgin PA11 + | Virgin PA11 + |
|---|---|---|---|---|
| | | 70% PA11 3D | 70% PA11 3D | 70% PA11 3D |
| | | Powder to be | Powder to be | Powder to be |
| | | recycled + 1.2% | recycled + 0.6% | recycled + 0.2% |
| | | by weight of | by weight of | by weight of |
| | Method | Adipic Acid | Adipic Acid | Adipic Acid |
| Modulus (Mpa) | ISO 527 1A (2019) | 1485 | 1440 | 1433 |
| Nominal | ISO 527 1A (2019) | <100 | 243 | 295 |
| Elongation | | | | |
| at Break (%) | | | | |
| Strain at | ISO 527 1A (2019) | <25 | 42 | 47 |
| Break (Mpa) | | | | |
| Charpy V-notch | ISO 179 1eA (2010) | 6 | 8 | 9 |
| Impact at 23° C. | | | | |
| (Kj/m²) | | | | |
| Charpy V-notch | ISO 179 1eA (2010) | 7 | 12 | 12 |
| Impact at −30° C. | | | | |
| (Kj/m²) | | | | |
| Inherent | according to the | 1.02 | 1.10 | 1.18 |
| Viscosity | standard ISO 307* | | | |
| | (2019) | | | |
| Ip = Mw/Mn | calculated based on | 3.8 | 4.4 | 5.1 |
| | Mw and Mn measured | | | |
| | according to ISO | | | |
| | 16014-1 (2012) | | | |
| Iz = Mz/Mn | calculated based on | 11.9 | 13.3 | 14.8 |
| | Mz and Mn measured | | | |
| | according to ISO | | | |
| | 16014-1 (2012) | | | |

*As measured using an Ubbelohde tube at 20° C. on a 0.5% by weight solution in m-cresol excepting the fact that the measurement temperature is 20° C. instead of 25° C.

The inherent viscosities and polydispersity indices Ip and Iz of the starting materials and the compositions according to the invention comprising a chain limiting agent.

The results show a deterioration in the mechanical strength of the polyamide composition for a chain limiting agent content of 1.2% by weight.

1-15. (canceled)

16. A composition preparation method for preparing a polyamide composition which comprises the steps of:
a) providing a mixture comprising:
from 5 to 90% by weight of a virgin polyamide vPA;
from 10 to 95% by weight of a polyamide to be recycled rPA;
relative to the total weight of the mixture;
the polyamide to be recycled rPA being in the form of an untransformed powder resulting from additive manufacturing by sintering or from a coating method by powdering or by electrostatic spraying, or of a powder obtained by grinding a polyamide-based part of an object to be recycled;
the molecular weight-polydispersity index Ip (Mw/Mn) of the virgin polyamide vPA being lower than the polydispersity index Ip of the polyamide to be recycled rPA, where Mw and Mn are measured by steric exclusion chromatography in accordance with the standard ISO 16014-1 of 2012;
b) kneading the said mixture in the molten state (melt kneading), as a result of which a polyamide composition is obtained whereof the molecular weight-polydispersity index Ip is greater than or equal to 1.5;
c) recovering the said polyamide composition.

17. The method according to claim 16, wherein the polyamide to be recycled rPA and the virgin polyamide vPA are homopolyamides.

18. The method according to claim 16, wherein the average number of carbon atoms (C) relative to the nitrogen atom (N) of the polyamide to be recycled rPA and/or of the virgin polyamide vPA is greater than or equal to 8.

19. The method according to claim 16, wherein the polyamide to be recycled rPA and the virgin polyamide vPA are independently selected from among PA11 or PA12.

20. The method according to claim 16, wherein the polyamide to be recycled rPA and the virgin polyamide vPA are identical in nature.

21. The method according to claim 20, wherein
the virgin polyamide is vPA11 and the polyamide to be recycled rPA is an rPA11, or
the virgin polyamide is vPA12 and the polyamide to be recycled rPA is an rPA12.

22. The method according to claim 16, wherein the inherent viscosity of the virgin polyamide vPA is lower than or equal to 1.50; and/or the powder of the mixture has an inherent viscosity that is greater than or equal to 1.50.

23. The method according to claim 22, wherein the inherent viscosity of the virgin polyamide vPA is lower than or equal to 1.40; and/or the powder of the mixture has an inherent viscosity that is greater than or equal to 1.60.

24. The method according to claim 23, wherein the inherent viscosity of the virgin polyamide vPA is lower than or equal to 1.30; and/or the powder of the mixture has an inherent viscosity that is from 0.70 to 5.00.

25. The method according to claim 16, wherein the molecular weight-polydispersity index Ip (Mw/Mn) of the virgin polyamide vPA is lower by at least 20% relative to the polydispersity index Ip of the polyamide to be recycled rPA;
or the polydispersity index Iz (Mz/Mn) of the virgin polyamide vPA is lower by at least 30% relative to the polydispersity index Iz of the polyamide to be recycled rPA, where Mn and Mz are measured by steric exclusion chromatography in accordance with the standard ISO 16014-1 of 2012.

26. The method according to claim 16, wherein the molecular weight-polydispersity index Ip of the virgin polyamide vPA is from 1.6 to 2.2, and/or the molecular weight-polydispersity index Ip of the polyamide to be recycled rPA is from 2.5 to 15.0.

27. The method according to claim 26, wherein the molecular weight-polydispersity index Ip of the virgin polyamide vPA is from 1.6 to 2.1, and/or the molecular weight-polydispersity index Ip of the polyamide to be recycled rPA is from 2.8 to 10.0.

28. The method according to claim 16, wherein the proportion by weight of chain limiting agent within the mixture is less than or equal to 1.0%.

29. A polyamide composition that is obtainable by the method according to claim 16, wherein the molecular weight-polydispersity index Ip (Mw/Mn) of the polyamides is greater than or equal to 1.5, where Mw and Mn are measured by steric exclusion chromatography in accordance with the standard ISO 16014-1 of 2012.

30. The polyamide composition according to claim 29, wherein the z average-polydispersity index Iz (Mz/Mn) of the polyamides of the composition is higher than that of the virgin polyamide used as starting material in the mixture, and/or the molecular weight-polydispersity index Ip of the polyamides of the composition is higher than that of the virgin polyamide used as starting material in the mixture, where Mn and Mz are measured by steric exclusion chromatography in accordance with the standard ISO 16014-1 of 2012.

31. The polyamide composition according to claim 29, wherein the z average-polydispersity index Iz of the polyamides of the composition (Mz/Mn) is greater than or equal to 3.0; and/or the molecular weight-polydispersity index Ip of the polyamides of the composition (Mw/Mn) is greater than 2.0.

32. The polyamide composition according to claim 29, whereof the inherent viscosity, as measured using an Ubbelohde tube at 20° C. on a 0.5% by weight solution in m-cresol according to the standard ISO 307 of 2019, is between 0.80 and 1.50.

33. An article preparation method for preparing an article that comprises a step of extrusion, moulding or overmoulding of the composition according to claim 29, as a result of which an article is obtained.
